(19) United States
(12) Patent Application Publication
(10) Pub. No.: US 2017/0331261 A1
(43) Pub. Date: Nov. 16, 2017

(54) IGNITION SYSTEM FOR AN INTERNAL COMBUSTION ENGINE AND A CONTROL METHOD THEREOF

(71) Applicant: NORTH-WEST UNIVERSITY, Potchefstroom (ZA)

(72) Inventors: Petrus Paulus KRÜGER, Potchefstroom (ZA); Barend VISSER, Potchefstroom (ZA)

(73) Assignee: NORTH-WEST UNIVERSITY, Potchefstroom (ZA)

(21) Appl. No.: 15/522,258

(22) PCT Filed: Oct. 30, 2015
(86) PCT No.: PCT/IB2015/058391

§ 371 Date: Apr. 26, 2017

(30) Foreign Application Priority Data
Oct. 30, 2014 (ZA) 2014/07931

(51) Int. Cl. H01T 13/44; H01T 13/50; H01T 13/04; H01T 19/00; F02P 9/00

(52) U.S. Cl. CPC H01T 13/44; H01T 19/00; F02P 9/002; H01T 13/04; H01T 13/50

(57) ABSTRACT

An ignition system (10) comprises a high voltage transformer (12) comprising a primary winding (12.1) and a secondary winding (12.2). A primary resonant circuit (26) is formed by the primary winding (12.1) and a primary circuit capacitance (24). A secondary resonant circuit (16) is formed by an ignition plug (14), as a load, the secondary winding (12.2); the ignition plug (14) being represented by a secondary circuit capacitance (18) and a secondary circuit load resistance (Rp) put in parallel. Said load resistance value varies during an ignition cycle. The primary resonant circuit (26) and the secondary resonant circuit (16) have a common mode resonance frequency (f_{c}) and a differential mode resonance frequency (f_{d}). A controller (28) is configured to cause a drive circuit (22) to drive the primary winding at a frequency, which is either the common-mode resonance frequency (f_{c}) or the differential mode resonance frequency (f_{d}) and is connected to a feed-back circuit (50) to adapt the frequency of the primary winding to the variable load resistance.

### INTRODUCTION AND BACKGROUND

This invention relates to an ignition system for an internal combustion engine and a method of driving an ignition plug of an ignition system.

In order to improve emissions in petrol internal combustion engines to meet emission standards, the engine needs to be operated with a high exhaust gas recycling (EGR) or lean air-fuel mixtures. A corona ignition plug which improves combustion stability under these conditions is known. However, these plugs cannot be driven by a conventional ignition coil, but must be driven at a high frequency and a high voltage under varying load conditions, as the corona is generated and then grows. The known ignition systems are complicated and expensive. One of the factors making existing corona systems expensive is the requirement that the power delivered to the corona must be controlled carefully, to prevent sparking.

Also, known spark plug ignition systems do not have the capability of controlling the amount of power delivered to a spark. The known systems deliver power proportional to the spark resistance. Because the amount of power delivered to the spark is not controllable and the spark resistance may differ between ignition cycles, the amount of power delivered to the spark may differ between cycles. The differences in power delivered may lead to undesirable differences in ignition and combustion between cycles.

### OBJECT OF THE INVENTION

Accordingly it is an object of the invention to provide an ignition system and method of driving an ignition plug with which the applicant believes the aforementioned disadvantages may at least be alleviated or which may provide a useful alternative for the known systems and methods.

### SUMMARY OF THE INVENTION

According to the invention there is provided an ignition system comprising:
a high voltage transformer comprising a primary winding having a first inductance L₁ and a secondary winding having a second inductance L₂;
a primary resonant circuit comprising the primary winding and a primary circuit capacitance C₁ and having a first resonant frequency f₁;
an ignition plug connected to the secondary winding as a load, in use, to form a secondary resonant circuit comprising the secondary winding, a secondary circuit capacitance C₂ and a secondary circuit load resistance Rp, the load resistance, in use and during an ignition cycle, changing between a first value that is high and a second value that is low, the secondary resonant circuit having a second resonant frequency f₂;
a drive circuit connected to the primary circuit to drive the primary winding at a drive frequency;
the magnetic coupling k between the primary winding and secondary winding being less than 0.5, so that a resonant transformer comprising the primary resonant circuit and the secondary resonant circuit collectively have a common-mode resonance frequency f_{c} and a differential-mode resonance frequency f_{d} when the load resistance is high; and
a controller connected to a feed-back circuit from at least one of the primary resonant circuit and the secondary resonant circuit and configured to cause the drive circuit to drive the primary winding at a variable frequency, which is dependent on the load resistance, and which load resistance is derived by the controller from the feed-back circuit.

In one embodiment of the invention the ignition plug is a corona plug for generating a corona only for ignition purposes and the controller may be configured when the load resistance is high, to cause the drive circuit to drive the primary winding at the common-mode resonance frequency to generate a corona and when a spark forms resulting in a low load resistance, to either a) stop driving the primary winding or b) driving the primary winding at a frequency substantially different from a resonance frequency, thereby to stop power transfer into the spark plasma.

In another embodiment of the invention the ignition plug is a spark plug for generating a spark for ignition purposes and the controller may be configured to cause the drive circuit when the load resistance is high, to drive the primary winding at one of the common-mode resonance frequency and the differential-mode resonance frequency thereby generating a high voltage to form a spark and when the load resistance is low, then driving the primary winding at a different frequency to deliver a predetermined amount of power to the load.

In embodiments wherein the drive frequency is equal to the common-mode frequency, the value of C₁ may be such that C₁<L₂C₂/(1+0.5k)L₁, thereby to improve an effective quality factor of the resonant transformer.

In embodiments wherein the drive frequency is equal to the differential-mode frequency, the value of C₁ may be such that C₁>L₂C₂/(1−0.5k)L₁, thereby to improve an effective quality factor of the resonant transformer.

According to another aspect of the invention there is provided a method of driving an ignition system comprising a high voltage transformer comprising a primary winding having a first inductance L₁ and a secondary winding having a second inductance L₂; a primary resonant circuit comprising the primary winding and a primary circuit capacitance C₁ and having a first resonant frequency f₁; an ignition plug connected to the secondary winding as a load, in use, to form a secondary resonant circuit comprising the secondary winding, a secondary circuit capacitance C₂ and a secondary circuit load resistance Rp, the load resistance, in use and during an ignition cycle, changing between a first value that is high and a second value that is low, the secondary resonant circuit having a second resonant frequency f₂; a drive circuit connected to the primary circuit to drive the primary winding at a drive frequency; the magnetic coupling k between the primary winding and secondary winding being less than 0.5, so that a resonant transformer comprising the primary resonant circuit and the secondary resonant circuit collectively have a common-mode resonance frequency f_{c} and a differential-mode resonance frequency f_{d} when the load resistance is high, the method comprising:
driving the primary winding at a variable frequency which is dependent on the load resistance.

In some forms of the method the ignition plug is a corona plug for generating a corona only for ignition purposes and the method may comprise when the load resistance is high, driving the primary winding at the common-mode resonance frequency to generate a corona and when a spark forms resulting in a low load resistance, then either a) stop driving the primary winding or b) driving the primary winding at a frequency substantially different from a resonance frequency, thereby to stop power transfer into the spark plasma.

In other forms of the method the ignition plug is a spark plug for generating a spark for ignition purposes and the method may comprise when the load resistance is high, driving the primary winding at one of the common-mode resonance frequency and the differential-mode resonance frequency thereby generating a high voltage to form a spark and when the load resistance is low, then driving the primary winding at a different frequency to deliver a predetermined amount of power to the load.

### BRIEF DESCRIPTION OF THE ACCOMPANYING DIAGRAMS

The invention will now further be described, by way of example only, with reference to the accompanying diagrams wherein:

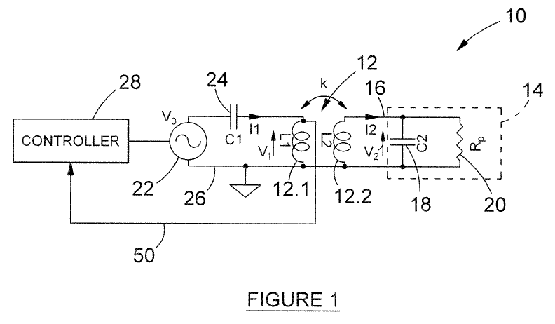

FIG. 1 is a high level circuit diagram of an example embodiment of an ignition system comprising an ignition plug;

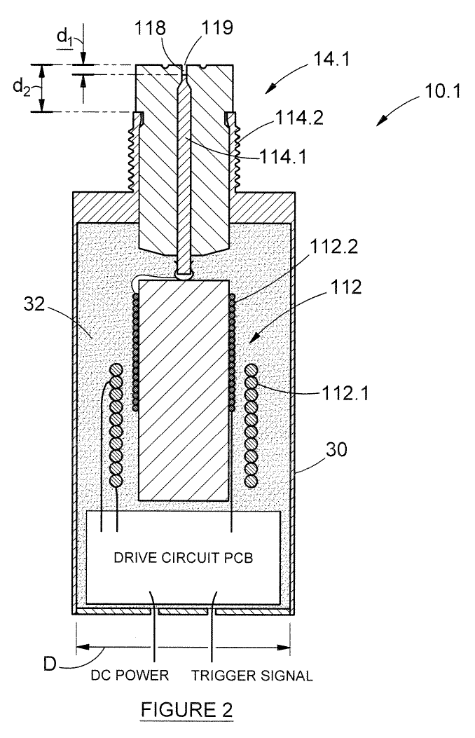

FIG. 2 is a diagrammatic sectional view of an example embodiment of the ignition system comprising an ignition plug in the form of a corona plug;

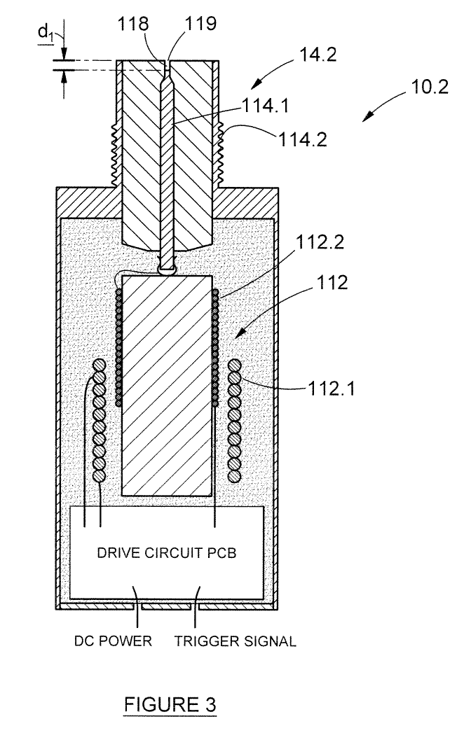

FIG. 3 is a similar view of another example embodiment of the ignition system comprising an ignition plug in the form of a spark plug;

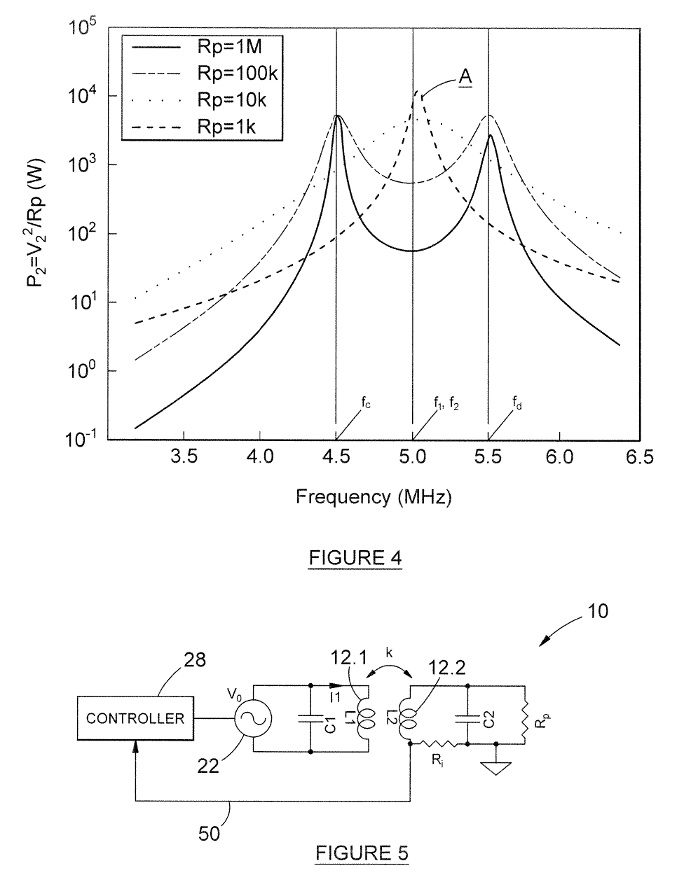

FIG. 4 is a graph of output power against drive frequency for different values of parallel load resistance Rₚ;

FIG. 5 is another high level circuit diagram of an example embodiment of the ignition system;

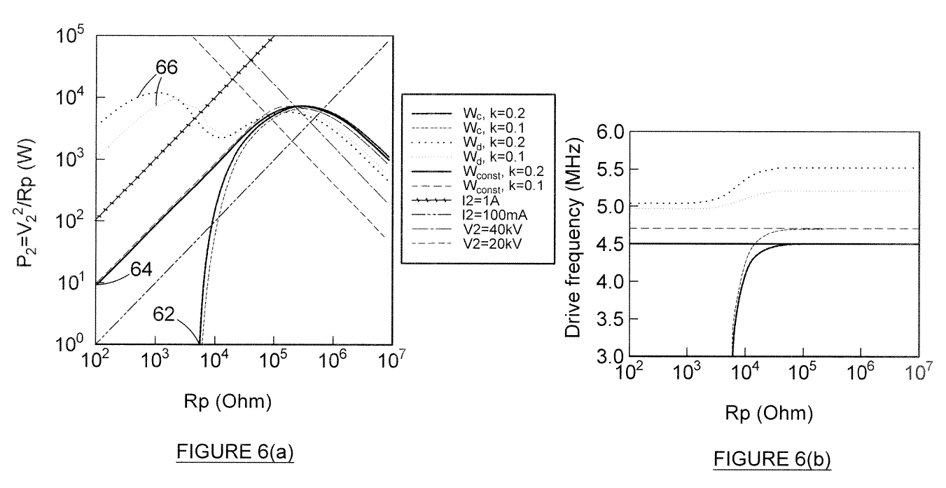

FIG. 6(a) show graphs of output power against parallel load resistance for different drive frequencies;

FIG. 6(b) show graphs of the common-mode and differential-mode frequency against parallel load resistance for different magnetic coupling coefficients;

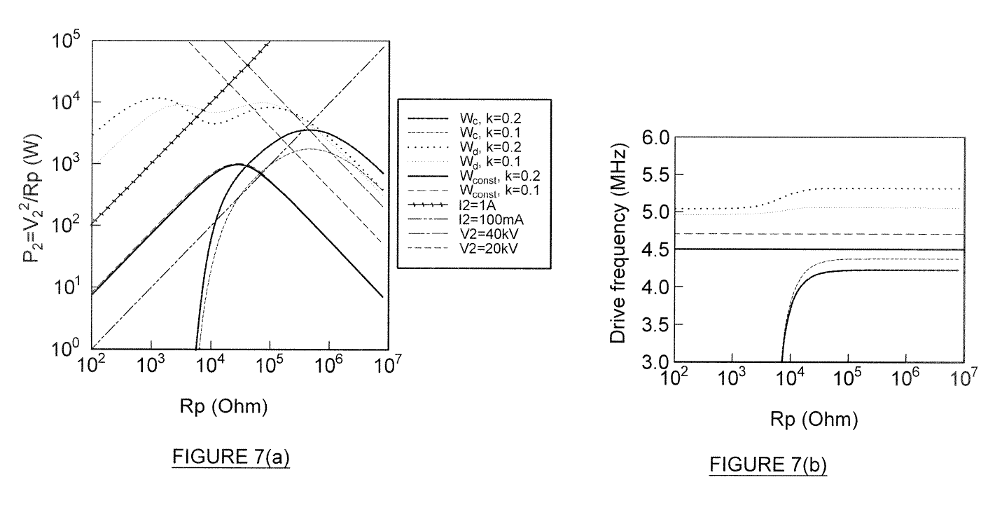

FIG. 7(a) is similar to FIG. 6(a), but with an increase in load capacitance of 20%;

FIG. 7(b) is similar to FIG. 6(b), but with an increase in load capacitance of 20%;

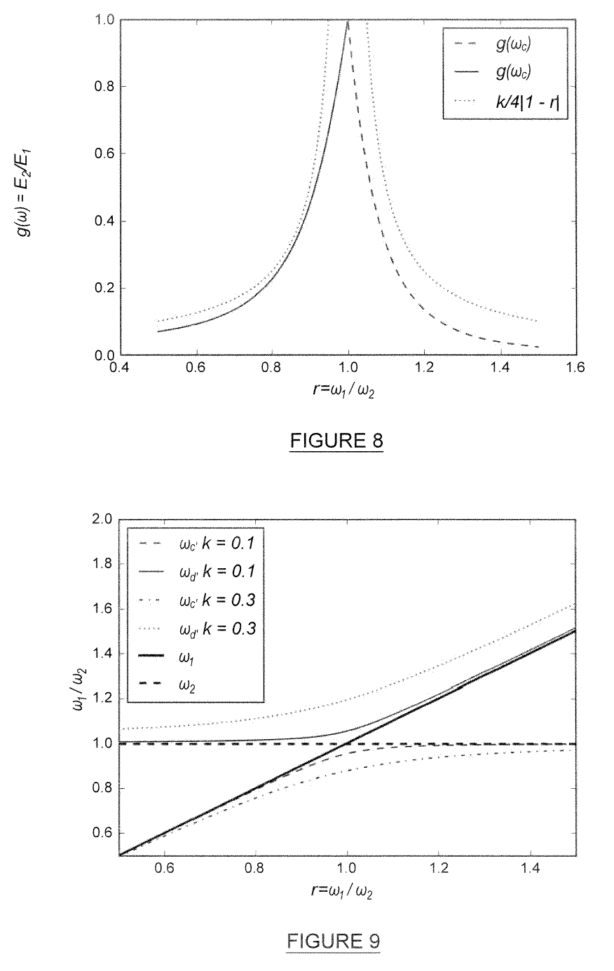

FIG. 8 are normalized graphs illustrating changes in common-mode resonant frequency ω_{c} and differential-mode resonant frequency ω_{d} as first and second resonant frequencies change relative to one another; and

FIG. 9 are graphs illustrating values of a factor g(ω) against a ratio of the first and second resonant frequencies.

### DESCRIPTION OF A PREFERRED EMBODIMENT OF THE INVENTION

Example embodiments of an ignition system are designated 10 in FIGS. 1 and 5, 10.1 in FIGS. 2 and 10.2 in FIG. 3.

Referring to FIG. 1, the ignition system comprises a high voltage transformer 12 comprising a primary winding 12.1 and a secondary winding 12.2. An ignition plug 14 is connected to the secondary winding as a load, in use, to form a secondary resonant circuit 16 comprising the secondary winding 12.2, a secondary circuit capacitance 18 and a load resistance 20 in parallel with the secondary winding 12.2. The load resistance 20 and the load capacitance 18 are mainly provided by the resistance and capacitance of a medium (gas and/or plasma) between electrodes 114.1 and 114.2 (shown in FIGS. 2 and 3) of the ignition plug. It is known that, in use and during ignition, the load resistance changes from a first and high value to a second and lower value and the load capacitance changes from a first and low value to a second and higher value. As a corona is generated at first, the capacitance increases and the load resistance decreases. When a spark is formed, the load resistance is suddenly and dramatically reduced. A capacitor 24 is connected in series with the primary winding 12.1 for a series configuration (see FIG. 1) or in parallel for a parallel configuration (see FIG. 5), to form a primary resonant circuit 26. A drive circuit 22 is connected to the primary circuit to drive the primary winding. The drive circuit may either be a voltage source (for the series configuration) or a current source (for the parallel configuration). The primary resonant circuit 26 has a first resonance frequency f₁ which is associated with a first angular resonance frequency and the secondary resonant circuit 16 has a second resonance frequency f₂ when the load resistance 20 is large (has its first value) and no second resonance frequency when the load resistance is small (has its second value). The second resonance frequency is associated with a second angular resonance frequency ω₂ and the second resonance frequency f₂ may be equal to or different from the first resonance frequency f₁. The magnetic coupling coefficient (k) between the primary winding 12.1 and secondary winding 12.2 is less than 0.5, so that a resonant transformer comprising the primary resonant circuit and the secondary resonant circuit has a common-mode resonance frequency f_{c} (shown in FIG. 4 and explained below) or angular frequency ω_{c} and a differential-mode resonance frequency f_{d} (also shown in FIG. 4 and explained below) or angular frequency ω_{d} when the load resistance has its first value, but only the differential-mode resonance frequency f_{d} when the load resistance approaches its second and low value.

As will be explained in more detail below, a controller 28 which is connected to a feedback circuit 50 from either the primary resonant circuit or the secondary resonant circuit is configured to cause the drive circuit 22 in the case of a corona plug 14.1 (shown in FIG. 2), to drive the primary winding 12.1 at the common-mode resonance frequency f_{c} to generate a corona and should a spark be formed with the concomitant drop in load resistance, to either i) stop driving the primary winding or ii) driving the primary winding at a frequency substantially different from the common-mode resonance frequency f_{c}, thereby to allow the spark to terminate. The controller can be configured to resume oscillation at the common-mode resonance once the spark is terminated.

In the case of a spark plug 14.2 (shown in FIG. 3), the controller is configured to cause the drive circuit to drive the primary winding 12.1 at one of the common-mode resonance frequency f_{c} and the differential-mode resonance frequency f_{d} until the load resistance becomes small and a spark is formed and then to drive the primary winding at a different frequency, to ensure that a predetermined amount of power is delivered to the spark.

Still referring to FIG. 1, transformer 12 has a primary inductance L₁ and secondary inductance L₂. Series capacitor 24 has a capacitance C₁ and the secondary load has a capacitance C₂ and parallel resistance Rₚ. It can be shown that when the first resonance frequency f₁ (or associated angular resonance frequency ω₁) and the second resonance frequency f₂ (or associated angular resonance frequency ω₂) are the same (ω_{1,2}=1/L₁C₁=1/L₂C₂), that the ignition circuit has two resonance frequencies,

$${ω}_{c , d} \approx \frac{{ω}_{1 , 2}}{\sqrt{1 \pm k}} ,$$

wherein ω_{c} is referred to as the common-mode resonance frequency (where the current in the primary winding 12.1 and the current in the secondary winding 12.2 are in phase) and ω_{d} is referred to as the differential-mode resonance frequency (where the currents are 180 degrees out-of-phase). As shown in FIG. 4, the common-mode resonance frequency ω_{c} is lower than the primary and secondary resonance frequencies ω₁=ω₂, whereas the differential-mode resonance frequency ω_{d} is higher than ω₁=ω₂. Referring to FIG. 4 and the above formula, f₁=f₂=5 MHz and k=0.2 give f_{c}=4.6 MHz and f_{d}=5.6 MHz.

Furthermore, in use, as a corona generated by the ignition plug grows, the load resistance Rₚ decreases and both ω_{c} and ω_{d} decrease (as shown in FIG. 6(b)). As Rₚ approaches the value ω₂L₂, the common-mode resonance frequency ω_{c} approaches zero and ω_{d} approaches ω₁. When Rₚ is smaller than ω₂−L₂, there is no common-mode resonance frequency ω_{c}, and ω_{d}=ω₁. This is also illustrated in FIG. 4 by the broken line marked A.

It can further be shown that the maximum voltage V₂ on the secondary side depends on the losses on the primary and secondary side and is almost independent of the magnetic coupling coefficient k. The transformer voltage ratio |V₂|/|V₁| is independent of the coupling coefficient k and is given by the well-known formula

$$\frac{\vert {V}_{2} \vert}{\vert {V}_{1} \vert} \approx \sqrt{\frac{{L}_{2}}{{L}_{1}}} .$$

The minimum coupling required is determined by the losses on the primary and secondary sides, and should be such that k²>1/Q₁. 1/Q₂ where

$${Q}_{1} = \frac{{w}_{1} {L}_{1}}{{R}_{1}} and {Q}_{2} = \frac{{w}_{2} {L}_{2}}{{R}_{2}}$$

are the quality factors of the primary and secondary circuits. R₁ and R₂ will be referred to in more detail below.

An example of an ignition system 10.1 for generating a corona is shown in FIG. 2 read with FIG. 1. The system 10.1 comprises a corona plug 14.1 (such as that described in the applicant's co-pending International Application entitled “Ignition Plug”, the contents of which are incorporated herein by this reference) connected to a transformer 112. An example of an ignition system 10.2 for generating a spark is shown in FIG. 3 read with FIG. 1. The system 10.2 comprises a spark plug 14.2 connected to a transformer 112.

The transformer comprises 200 secondary winding turns with a diameter of about 10 mm over a length of 20 mm inside a metal tube 30 having a diameter D of about 20 mm filled with a body 32 of non-magnetic material. The secondary winding 112.2 has an inductance of about L₂=130 pH. When connected to a corona plug 14.1, the secondary load capacitance is about C₂=7 pF, resulting in a secondary resonance frequency of f₂=ω₂/2π=5.3 MHz. The primary winding 112.1 comprises 10 winding turns with diameter of about 10 mm having an inductance of about 530 nH, connected to series capacitor 24 having a capacitance C₁ of 1.7 nF, resulting in a first resonance frequency of f₁=ω₁/2π=5.3 MHz. The coupling coefficient k is determined by the overlap between the windings 112.1 and 112.2 and is typically between k=0.05 and k=0.4. The quality factor of the two resonators (the primary and secondary circuits) is about Q₁=Q₂=100, so that the product Q₂Q₁k²>25 for k>0.05. The ignition circuit is driven by a drive circuit outputting a 200V peak-to-peak square wave. The voltage on the primary side winding is then about V₁=3 kV and the output voltage is about V₂=V₁\sqrt{L/L₁}=46 kV when driven at one of the resonance frequencies for a large load. When the load is 1 MO, the power delivered to the load is P₂=V²/R=2 kW at resonance as shown in FIG. 4.

A normal spark plug can also be used in the place of the spark plug 14.2. However, to prevent unwanted corona on the spark plug ceramic, a lower drive frequency must be utilized. In such a case, the secondary winding 112.2 may comprise 740 turns with a diameter of 10 mm around a ferrite magnetic material, resulting in a secondary inductance of L₂=7.5 mH. The secondary side capacitance, including the spark plug capacitance, is about 30 pF, giving a second resonance frequency f₂ of 340 kHz. The primary winding 112.1 comprises 12 turns around the same magnetic material, resulting in an inductance of L₁=4 pH, and the same resonance frequency f₁ of 340 kHz when connected to series capacitor 24 of 56 nF. The ignition circuit is driven by a drive circuit 22 which outputs a 200V peak-to-peak square wave. When driven at resonance for a large load, the voltage on the primary winding is about V₁=1 kV and the output voltage is about V₂=43 kV.

As shown in FIG. 6(a), the power P₂=V₂²/Rₚ delivered to the load 14 as a function of the load resistance Rₚ is determined by the frequency of the drive circuit 22. Using feedback as shown at 50 in FIGS. 1 and 5, the primary winding 12.1 may be driven at the common-mode resonance frequency f_{c} alternatively differential-mode resonance frequency f_{d}, as they respectively change in use. Alternatively, the system 10 may be driven at a constant frequency f_{const}, such as 4.5 MHz as shown in FIG. 6(b). The power as function of resistance is shown in FIG. 6(a) for these three cases.

From FIG. 6(a) it can be seen that driving the system at the common-mode resonance frequency f_{c} will inherently suspend power transfer when the load resistance becomes small, as shown at 62. Hence the system and method inherently reduce the power the moment a spark is formed. Driving the circuit at the constant frequency f_{const} will deliver a constant current into small loads as shown at 64 and driving the system at the differential-mode resonance frequency f_{d} will result in very high power delivered into small loads as shown at 66.

The effect of changes in load capacitance C₂ as the corona grows can be seen by increasing the secondary capacitance by 20% for example, thereby reducing the common-mode resonance frequency by about 10% as shown in FIG. 7(b). When the drive frequency is fixed to the common-mode resonant frequency without the extra capacitance, the system will not be driven at resonance any more with the extra capacitance. This will result in a much lower high voltage V₂ than driving the system at the common-mode resonance frequency f_{c}.

The drive circuit 22 can be configured to oscillate at the common-mode (or differential-mode) frequency by sensing, as shown in FIG. 5, the secondary current and driving the primary circuit 26 in phase (or 180 degrees out of phase) with the secondary current.

Hence, two weakly coupled resonators may be used to generate a high voltage in an ignition system. With the controller 28 causing the drive circuit 22 to follow the changing common-mode or differential-mode resonance frequencies as the load changes, the amount of power transferred to the load may be controlled. There is the unexpected result in a corona ignition system that when the system is driven at the common-mode resonance frequency, power transfer is inherently reduced the moment a spark is formed, as shown at 62 in FIG. 6(a).

As stated above, the primary winding 12.1 is connected to capacitor C₁ in either series (FIG. 1) or parallel (FIG. 5) and to drive circuit 22. The capacitance C₁ and inductance L₁ form a first resonant circuit having a first angular resonant frequency ω₁²=1/L₁C₁. Due to losses in the first resonant circuit, the circuit has a first quality factor C₁, so that the losses at an angular frequency ω can be presented by an equivalent series resistance R₁ given by Q₁=ωL₁/R₁, or an equivalent parallel resistance.

The secondary winding is connected to load 14 such as an ignition plug. The capacitance of the secondary winding and load can be presented by parallel capacitor C₂. The loss of the secondary winding and the resistance of the load can be presented by parallel resistor Rₚ. The capacitance C₂ and inductance L₂ forms a resonant circuit having a secondary angular resonant frequency ω₂²=1/L₂C₂. The quality factor Q₂ of the secondary side at an angular frequency ω is given by Q₂=Rₚ/ωL₂. The description below relates to a case when the resistance Rₚ is large, i.e. when there is not a spark between the electrodes of the ignition plug.

Due to the magnetic coupling between the primary and secondary windings, the first and second circuits form a combined resonant circuit, called a resonant transformer. This resonant transformer does not resonate as either the first angular frequency ω₁ or secondary angular frequency ω₂, but has two other resonant frequencies, called the common-mode resonant frequency f_{c} and the differential-mode resonant frequency f_{d} (as shown in FIG. 4 for Rₚ>100kΩ).

For the special case when the first and secondary angular frequencies are the same ω₁=ω₂ (i.e. L₁C₁=L₂C₂) the common-mode angular resonant frequency is given by ω_{c}²/(1+k) and the differential-mode angular resonant frequency is given by ω_{d}²=²/(1−k). However as ω₁ becomes larger than ω₂ (ω₁>ω₂) the common-mode frequency becomes closer to the second resonant frequency ω_{c}→ω₂ and the differential-mode frequency becomes closer the first resonant frequency ω_{d}→ω₁. Similarly, as ω₁ becomes smaller than ω₂ (ω₁<ω₂), ω_{c}→ω₁ and ω_{d}→ω₂. This is shown in the FIG. 8 where the frequencies are normalised with respect to ω₂.

When the resonant transformer is driven at any one of its two resonant frequencies, the primary current I₁ (FIG. 1) is in phase with the supply voltage V₀ and a push-pull drive circuit 22 may be switched at zero current when connected in series as in FIG. 1, or it switches at zero voltage when connected in parallel as in FIG. 5. This has the first advantage that switching losses are small.

A second advantage of the resonant transformer being driven at resonance is that each oscillation cycle transfers energy to the secondary circuit so that the energy (and therefore high voltage) in the secondary circuit builds up with each additional cycle until steady state is achieved when the energy loss equals the energy transferred during each cycle. The result is that the energy in the secondary circuit is much more than the energy supplied by the drive circuit during each cycle. This can be presented by the equation |V₂∥I₂|=Q_{eff}V₀I₁, where the power in the secondary circuit is presented by the product of the magnitudes of the secondary voltage |V₂| and secondary current |I₂|, the supplied power is given by V₀ and I₁ (which are in phase) and Q_{eff}>1 is the effective quality factor of the resonant transformer. To generate a spark or to grow a corona, a secondary voltage of about 30 kV is required. This means that the larger Q_{eff}, the smaller (less powerful) drive circuit can be used to generate the same output voltage, which is cheaper, simpler and more reliable than a more powerful drive circuit.

Resonant transformers having ω₁=ω₂ are commonly used in so-called Tesla coils. However, when ω₁=ω₂ (i.e. L₁C₁=L₂C₂), the effective quality factor at both the common- and differential-mode resonant frequencies are determined by the quality factors of both the primary and secondary circuit of the transformer i.e. Q_{eff}≈Q₁Q₂/(Q₁+Q₂) or Q_{eff}⁻¹=Q₁⁻¹Q₂⁻¹. The primary winding normally consists of only a few turns and the current in the primary winding is much more than in the secondary winding. The result is that the primary circuit has more losses than the secondary circuit, Q₁<Q₂ so that the effective quality factor Q_{eff}<Q₁<Q₂, which is unwanted.

However, when ω₁≠ω₂ we have the unexpected effect that the effective quality factor Q_{eff} increases at one of the common- and differential-mode resonant frequencies and decreases at the other one. The effective quality factor at the common and differential-mode frequency can be written as Q_{eff}^{-l}(ω_{c})≈g(ω_{c})Q₁⁻¹+Q₂⁻¹ and Q_{eff}⁻¹(ω_{d})≈g(ω_{d})Q⁻¹Q₂⁻¹ with the function g(ω)=(−ω₂²/w 1)²/k². The function g(ω) can be interpreted as the ratio of the energy stored in the secondary and primary resonant circuits. It is therefore clear that as either the common- or differential-mode resonant frequency approaches ω₂, i.e. ω_{c,d}→C₂, the effective quality factor at that resonance approach Q₂, i.e. Q_{eff}(ω_{c,d})→C₂.

Let ω₁ be larger or smaller than ω₂ by a factor r, i.e. ω₁≈ω₂. It can then seen from FIG. 9 that as ω₁ becomes larger than ω₂ (ω₁<ω₂), g(ω_{c})→0, Q_{eff}(ω_{c})→Q₂ and the common-mode resonance become more efficient and as ω₁ becomes smaller than ω₂ (ω₁<ω₂) g(ω_{d})→0, Q_{eff}(ω_{d})→Q₂ and the differential-mode resonance becomes more efficient.

The figure also shows that g≦k/(4∥−ω₁/ω₂|). This makes it possible to estimate the improvement in the effective quality factor in terms of ω₁²=1/L₁C₁ and ω₂²=1/L₂C₂.

The effect of Q₁ will be at least two (2) times smaller (g<½) at the differential-mode resonance when k/4(1−r)<½, i.e. when L₂C₂<(1−½k)L₁C₁ and the effect of Q₁ will be less than half at the common-mode resonance when L₂C₂>(1+½)L₁C₁.

The effect of Q₁ will be at least 4 times smaller (g<¼) at the differential-mode resonance when k/(4(1−r))<¼, i.e. when L₂C₂<(1−k)L₁C₁ and the effect of Q₁ will be less than half at the common-mode resonance when L₂C₂>(1+k)L₁C₁.

Example embodiments of a corona plug and a spark plug are shown in FIGS. 3 and 2, respectively. These example embodiments may comprise an elongate cylindrical body of an electrically insulating material having a first end and a second end opposite to the first end. A first face is provided at the first end. A first elongate electrode 114.1 extends longitudinally in the body. The first electrode has a first end and a second end. The first electrode terminates at the first end thereof a first distance d1 from the first end of the body in a direction towards the second end of the body. The body hence defines a blind bore 118 extending between the first end of the first electrode and a mouth 119 at the first end of the body. A second electrode 114.2 is provided on an outer surface of the body and the second electrode terminates at one of a) flush with the first face of the body (for a spark plug as shown in FIG. 3) and b) a second distance d2 from the first end of the body in a direction towards the second end of the body (for a corona plug as shown in FIG. 2).

The generated spark extends between the first and second electrodes through the mouth 119 into a chamber with ignitable gasses where in at least part of its extent, it is surrounded by the gasses. The corona extends from the first electrode through the mouth 119 in finger like manner into the chamber, where in at least part of its length it is surrounded by the gasses.

1. An ignition system comprising:
a high voltage transformer comprising a primary winding having a first inductance L₁ and a secondary winding having a second inductance L₂;
a primary resonant circuit comprising the primary winding and a primary circuit capacitance C₁ and having a first resonant frequency f₁;
an ignition plug connected to the secondary winding as a load, in use, to form a secondary resonant circuit comprising the secondary winding, a secondary circuit capacitance C₂ which comprises capacitance of the secondary winding and capacitance presented by the load and a secondary circuit load resistance Rp which comprises losses in the secondary winding and resistance presented by the load, the secondary circuit load resistance, in use and during an ignition cycle, changing between a first value that is high and a second value that is low, the secondary resonant circuit having a second resonant frequency f₂;
a drive circuit connected to the primary circuit to drive the primary winding;
the magnetic coupling k between the primary winding and secondary winding being less than 0.5, so that a resonant transformer comprising the primary resonant circuit and the secondary resonant circuit collectively have a common-mode resonance frequency f_{c} and a differential-mode resonance frequency f_{d} when the load resistance is high; and
a controller connected to a feed-back circuit from at least one of the primary resonant circuit and the secondary resonant circuit and configured to cause the drive circuit, during an ignition cycle, to drive the primary winding at a variable frequency, which is dependent on the changing secondary circuit load resistance, and which changing secondary load resistance is derived by the controller from the feed-back circuit.

2. The ignition system as claimed in claim 1 wherein the ignition plug is a corona plug for generating a corona only for ignition purposes and wherein the controller is configured when the load resistance is high to cause the drive circuit to drive the primary winding at the common-mode resonance frequency to generate a corona and when a spark forms resulting in a low load resistance, to either a) stop driving the primary winding or b) driving the primary winding at a frequency substantially different from a resonance frequency, thereby to stop power transfer into the spark plasma.

3. The ignition system as claimed in claim 1 wherein the ignition plug is a spark plug for generating a spark for ignition purposes and wherein the controller is configured to cause the drive circuit when the load resistance is high to drive the primary winding at one of the common-mode resonance frequency and the differential-mode resonance frequency thereby generating a high voltage to form a spark and when the load resistance is low, then driving the primary winding at a different frequency to deliver a predetermined amount of power to the load.

4. The system as claimed in claim 2 wherein when the drive frequency is equal to the common-mode frequency, the value of C₁ is such that C₁<L₂C₂/(1+0.5k)L₁, thereby to improve an effective quality factor of the resonant transformer.

5. The system as claimed 3 wherein when the drive frequency is equal to the differential-mode frequency, the value of C₁ is such that C₁>L₂C₂/(1−0.5k)L₁, thereby to improve an effective quality factor of the resonant transformer.

6. A method of driving an ignition system comprising a high voltage transformer comprising a primary winding having a first inductance L1 and a secondary winding having a second inductance L2; a primary resonant circuit comprising the primary winding and a primary circuit capacitance C1 and having a first resonant frequency f₁; an ignition plug connected to the secondary winding as a load, in use, to form a secondary resonant circuit comprising the secondary winding, a secondary circuit capacitance C₂ which comprises capacitance of the secondary winding and capacitance presented by the load and a secondary circuit load resistance Rp which comprises losses in the secondary winding and resistance presented by the load, the secondary circuit load resistance, in use and during an ignition cycle, changing between a first value that is high and a second value that is low, the secondary resonant circuit having a second resonant frequency f₂; a drive circuit connected to the primary circuit to drive the primary winding at a drive frequency; the magnetic coupling k between the primary winding and secondary winding being less than 0.5, so that a resonant transformer comprising the primary resonant circuit and the secondary resonant circuit collectively have a common-mode resonance frequency f_{c} and a differential-mode resonance frequency f_{d} when the load resistance is high, the method comprising:
during an ignition cycle, driving the primary winding at a variable frequency which is dependent on the changing secondary circuit load resistance.

7. A method as claimed in claim 6 wherein the ignition plug is a corona plug for generating a corona only for ignition purposes and wherein when the load resistance is high, the primary winding is driven at the common-mode resonance frequency to generate a corona and when a spark forms resulting in a low load resistance, then either a) stop driving the primary winding or b) driving the primary winding at a frequency substantially different from a resonance frequency, thereby to stop power transfer into the spark plasma.

8. A method as claimed in claim 6 wherein the ignition plug is a spark plug for generating a spark for ignition purposes and wherein when the load resistance is high, the primary winding is driven at one of the common-mode resonance frequency and the differential-mode resonance frequency thereby generating a high voltage to form a spark and when the load resistance is low, then driving the primary winding at a different frequency to deliver a predetermined amount of power to the load.

9. The system as claimed in claim 3 wherein when the drive frequency is equal to the common-mode frequency, the value of C₁ is such that C₁<L₂C₂/(1+0.5k)L₁, thereby to improve an effective quality factor of the resonant transformer.
